(19) United States
(12) Patent Application Publication
(10) Pub. No.: US 2008/0293555 A1
(43) Pub. Date: Nov. 27, 2008

(54) Centrifuge With Rotor Identification by Means of a Transponder

(76) Inventor: Harald Hermle, Mahlstetten (DE)

Correspondence Address: BACHMAN & LAPOINTE, P.C., 900 CHAPEL STREET, SUITE 1201, NEW HAVEN, CT, 06510, US

(21) Appl. No.: 10/585,789

(22) PCT Filed: Jan. 12, 2005
(86) PCT No.: PCT/EP05/00202

§ 371 Date: Aug. 7, 2008

(30) Foreign Application Priority Data
Jan. 14, 2004 (DE) 10 2004 002 110.4

(51) Int. Cl. B04B 9/10

(52) U.S. Cl. 494/7

(57) ABSTRACT

A centrifuge has a rotor for receiving a sample to be centrifuged. The rotor is detachably mounted on a rotary shaft that is connected to a drive. A transponder is associated with the rotor, and an antenna connected to a writing/reading unit is associated with the transponder on a static element.

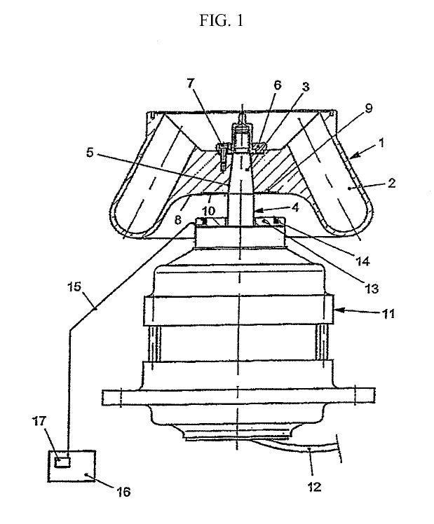

The present invention relates to a centrifuge having a rotor for holding a sample to be centrifuged, the rotor being detachably seated on a rotary shaft that is connected to a drive.

### PRIOR ART

The centrifuging of a biological or chemical sample in order to separate the sample constituents requires high angular speeds. It is known that a rise in angular speed produces faster and/or more finely subdivided separations. An attempt is made for this reason to set the rotor speed as high as possible.

In this regard, various samples are also supplied with various rotors that can be operated with a basic model of a centrifuge. That is to say, the rotor is to be exchangeable. A rotor model is selected for a specific separation operation on the basis of the mechanical properties of this rotor model. The availability of a multiplicity of types of rotors increases the versatility of the centrifuge in biological and chemical experimental research.

Each rotor model has a maximum, safe nominal speed that is a function in general of the maximum permissible loads and forces produced by centrifugal forces. Operating above the speed that is fixed for safe operation of the rotor can lead to a catastrophic rotor failure. It is therefore exceptionally important that the control of a centrifuge identifies which rotor is being operated.

Rotor identifiers previously known chiefly use inductive or optical identification systems in order to safeguard the rotating rotor. In the case of inductive systems, magnets fastened on the rotor in specific circular or annular arrangements as well as various numbers of magnets and a Hall sensor, fastened on the motor or bearing neck of the drive are used to ensure that use is made only of a rotor having a specific, permitted speed. Small distance tolerances of magnets and sensor systems, susceptibility in the case of soiling and mechanical loading are disadvantageous in the systems.

DE 38 18 594 A1 discloses a centrifuge in which there are provided on the rotor scannable code markings that include rotor-specific data. The markings are optically or magnetically scannable markings. A similar centrifuge is also described in EP 0 563 191 A2.

EP 0 714 324 B1 discloses a centrifuge system, the rotor being located in a housing with a sealable cover. A first transponder component is connected to the cover. A second transponder component is located in a head with which the rotor is fastened on the rotary shaft. Inherent in this arrangement of two transponder components is the disadvantage that the cover of the housing must always be sealed, and this is not required in many applications. Again, two transponder components raise the cost of the entire apparatus.

### OBJECT

The present invention is based on the object of developing a centrifuge of the above named type in the case of which the rotor and a multiplicity of data of the rotor can be reliably identified in a simple way.

### Achievement of the Object

Contributing to the achievement of the object is the fact that the rotor is assigned a transponder and the latter is assigned on a static element an antenna that is connected to a write/read unit.

The present invention therefore manages with a single transponder to which the antenna is always assigned at the same location. It is thereby impossible for difficulties to occur in the assignment of antenna and transponder.

The transponder according to the invention is a transceiver that operates using the query/response system. A coded query signal received by the transponder is decoded and evaluated after identification and other information from the enquirer. Thereupon, a coded response signal, selectively determined for the enquirer, which has the desired information and is likewise automatically decoded and evaluated at the enquirer's end is automatically emitted.

All rotor-specific data are preferably recorded in the transponder. These are, for example: year of manufacture, serial number of manufacture, maximum centrifuge action radius, maximum rotational frequency, parameters for the drive control, temperature compensation values, permissible unbalance values, etc. Moreover, further data such as, for example, operating hours, run times, number of starts, etc, are to be stored continuously in the transponder.

The transponder is insensitive to external influences such as soiling, magnetism, icing in cold centrifuges, many chemicals, detergents and mechanical friction arising from daily handling, and moreover is insensitive to temperatures occurring during normal sterilization in autoclaves.

The transponder is largely shielded in the groove at the lower plane surface of the rotor. This is a location on the rotor at which the transponder is largely shielded. This applies both to mechanical loads and, above all, to possible loads arising from the contents of the sample. An amount of the contents of a sample spilt into a corresponding cutout in the rotor during use of the sample therefore does not come into contact with the transponder.

An even better shielding or protection of the transponder is provided when the transponder is admitted into a groove in the lower plane surface of the rotor. The transponder can be fixed in this groove with the aid of an appropriate adhesive.

The antenna is preferably located in turn opposite the transponder, for example on or in a corresponding motor flange that separates the drive from the rotor. The antenna can be of annular configuration.

An arrangement of the individual components that is selected in such a way is simple and at the same time insensitive to distance tolerances. Manipulation and mounting are simple and for this reason exhibit very little susceptibility.

The write/read unit preferably produces an RF field at the antenna. As soon as the rotor is mounted on the rotary shaft, and a transponder is therefore located in the field, the transponder can be read out and/or written to. The write/read unit is, in turn, preferably arranged on the control printed circuit board of the electronics.

The most substantial advantage of the present invention resides in the fact that the centrifuge runs become substantially shorter, since it is rendered no longer necessary firstly to allow a rotor newly mounted on the rotary shaft firstly to start up in order to be identified, and then to shut it down again. This has been a considerable disadvantage with heavy rotors, in particular. In accordance with the present invention, the rotor is identified immediately after being mounted and fastened on the rotary shaft, this being done by reading out the data present in the transponder. Upon detection of approval of a machine, the centrifuge can be sealed and started immediately without having to delay until a set, or permissible rotational speed is reached.

A further substantial advantage is that each new rotor can be inserted without changing the basic machine software, and thus any user can exchange the rotors without additional outlay. Again, the supplier of the new rotor has no need to train the customer, since the centrifuge itself identifies the rotor and determines the speed. Given appropriately stored data, the control of the centrifuge also identifies when there is a need to exchange a rotor, for example as a consequence of an excessively high unbalance or an excessively great age, operating time etc.

In addition, the transponder is programmed individually for each rotor shortly before being delivered.

### DESCRIPTION OF THE FIGURE

Further advantages, features and details of the invention emerge from the following description of a preferred exemplary embodiment as well as with the aid of the drawing; the latter shows in a single FIGURE a side view, illustrated partially in section, of parts of a centrifuge according to the invention.

A rotor 1 of a centrifuge is shown that has holders 2 that are intended for holding samples to be treated, and are inclined obliquely outward. This rotor 1 is seated on a conical region 3 of a rotary shaft 4, a corresponding opening 5 in the rotor 1 being designed in a correspondingly conical fashion. A hood 6 and corresponding fastening elements 7 fix the rotor 1 on the conical region 3 of the rotary shaft 4.

A groove 9 is formed in a lower plane surface 8 of the rotor 1, and a transponder 10 is inserted into this groove 9 and preferably bonded therein.

The rotary shaft 4 is driven by a drive 11. The drive 11 is preferably an electric motor that is connected to a supply source via an appropriate line 12.

A motor flange 13 is seated on the drive 11 in a fashion facing the plane surface 8 and has located in it an antenna 14, likewise in a fashion facing the plane surface 8. This antenna 14 is of annular configuration and is seated in a correspondingly shaped groove in the motor flange 13.

The antenna 14 is connected to a write/read unit 17 via a line 15. This write/read unit 17 is integrated on the control 16.

The mode of operation of the present invention is as follows:

As early as the production of the rotor 1, all rotor-specific data are stored in the transponder belonging to this rotor 1. These include, inter alia, permissible unbalance values and the maximum rotational speed. If this rotor 1 is mounted on the rotary shaft 4, and the control 16 is switched on, the control 16 identifies these rotor-specific values at once via the antenna 14, and can therefore control the drive 11.

If the rotor 1 is to be exchanged for another rotor, since, for example, another speed is desired, the write/read unit 17 inputs the operating time into the transponder 10 of the rotor 1 to be exchanged, and said operating time is added up, as appropriate, with an operating time already present.

After the new rotor has been mounted, its data are identified by the write/read unit 17 such that the latter can take over again the control of the drive in accordance with the new data.

List of reference numerals

| | |
|---|---|
| 1 | Rotor |
| 2 | Holder |
| 3 | Conical region |
| 4 | Rotary shaft |
| 5 | Opening |
| 6 | Hood |
| 7 | Fastening element |
| 8 | Plane surface |
| 9 | Groove |
| 10 | Transponder |
| 11 | Drive |
| 12 | Line |
| 13 | Motor flange |
| 14 | Antenna |
| 15 | Line |
| 16 | Control |
| 17 | Write/read unit |
| 18 | |
| 19 | |
| 20 | |
| 21 | |
| 22 | |
| 23 | |
| 24 | |
| 25 | |
| 26 | |
| 27 | |
| 28 | |
| 29 | |
| 30 | |
| 31 | |
| 32 | |
| 33 | |
| 34 | |
| 35 | |
| 36 | |
| 37 | |
| 38 | |
| 39 | |
| 40 | |
| 41 | |
| 42 | |
| 43 | |
| 44 | |
| 45 | |
| 46 | |
| 47 | |
| 48 | |
| 49 | |
| 50 | |
| 51 | |
| 52 | |
| 53 | |
| 54 | |
| 55 | |
| 56 | |
| 57 | |
| 58 | |
| 59 | |
| 60 | |
| 61 | |
| 62 | |
| 63 | |
| 64 | |
| 65 | |
| 66 | |
| 67 | |
| 68 | |
| 69 | |
| 70 | |
| 71 | |
| 72 | |
| 73 | |
| 74 | |
| 75 | |
| 76 | |
| 77 | |
| 78 | |
| 79 | |

1-7. (canceled)

8. A centrifuge having a rotor for holding a sample to be centrifuged, the rotor being detachably seated on a rotary shaft that is connected to a drive, the rotor including a transponder, an antenna connected to a write/read unit, a groove for holding the transponder, and said groove being located in a lower plane surface of the rotor.

9. The centrifuge as claimed in claim 8, wherein the transponder has a disk-shaped configuration.

10. The centrifuge as claimed in claim 8, wherein the transponder is bonded into the groove.

11. The centrifuge as claimed in claim 8, wherein the antenna is arranged on or in a motor flange positioned within a space formed by the lower plane surface of the rotor.

12. The centrifuge as claimed in claim 8, wherein the antenna has an annular configuration.
